(19) United States
(12) Patent Application Publication
(10) Pub. No.: US 2004/0145761 A1
(43) Pub. Date: Jul. 29, 2004

(54) Communication device having facsimile function

(75) Inventor: Tetsuya Kuwahara, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/738,683

(22) Filed: Dec. 17, 2003

(30) Foreign Application Priority Data
Jan. 28, 2003 (JP) 2003-019567

(51) Int. Cl. G06K 15/02; H04N 1/00; G06F 3/12

(52) U.S. Cl. 358/1.11; 358/1.18; 358/400

(57) ABSTRACT

A communication device having a facsimile function includes a first generating unit that generates a first transmission image by appending additional information using a bitmap font to an image to be transmitted by facsimile, a second generating unit that generates a second transmission image which the additional information is appended to the image using an outline font by an extension unit that prints out using the outline font and a transmission unit that transmits the first transmission image or the second transmission image in accordance with a facsimile protocol.

### BACKGROUND OF THE INVENTION

1. Field of the Invention

The present invention relates to communication technology, and more particularly to printing technology of a communication device having a facsimile function.

2. Description of Related Art

Printers and facsimile machines are known information devices having a printing function. For example, by analyzing the printer language included in printing data in the Printer Job Language (PJL) or the Printer Description Language (PDL) format, the printer performs imaging of each of the characters included in a document and prints out the printing data. Therefore, in general, it is necessary for the printer to have data that associates a character code with a shape of each character (hereinafter referred to as “font data”).

The font data is necessary for printing out a desired document by the printer. When there is no font data that is designated by the printing data, a printer may obtain necessary font data from another computer having the font data and print out the document.

Meanwhile, since a facsimile machine scans a document and handles the document as image data, the facsimile machine does not require the font data for printing out the document. However, many facsimile machines include a function for automatically appending transmitter information to an image or a function for automatically generating a cover page. Therefore, in general, the facsimile machines store as the font data, a bitmap font having a low resolution. Thus, the transmitter information or the cover page appended automatically by the facsimile machines results in characters having a rough resolution.

### SUMMARY OF THE INVENTION

The present invention was made in consideration to the above-described circumstance. An advantage of the present invention is to provide technology for appending prescribed information using characters with few rough edges by a communication device such as a facsimile machine, and a technology for improving visibility of information appended by the communication device.

According to one aspect of the present invention, a communication device having a facsimile function includes a first generating unit that generates a first transmission image by appending additional information using a bitmap font to an image to be transmitted by facsimile. The communication device also includes a second generating unit that generates a second transmission image, which additional information is appended using an outline font to an image to be transmitted by facsimile, by an extension unit that prints out by using the outline font. In addition, the communication device includes a transmission unit that transmits the first transmission image or the second transmission image in accordance with a facsimile protocol. Therefore, the information appended automatically by the communication device to an original image to be transmitted by facsimile can have a legible font type.

When the extension unit is used, the second generating unit instructs the extension unit to generate an image of a cover page. Accordingly, the communication device can form the cover page to have a legible font type.

According to another aspect of the present invention, a communication device having a facsimile function includes a reception unit that receives facsimile data in accordance with a facsimile protocol. The communication device also includes a first imaging unit which performs imaging of additional information included in the facsimile data by using a bitmap font. In addition, the communication device includes a second imaging unit which performs imaging of the additional information by using an outline font by an extension unit that prints out by using the outline font.

Further, any combination of the above constituent elements, modification and variation of the expression of the present invention into a method, a device, a system, a recording medium, a computer program or the like are also effective as embodiments of the present invention.

### BRIEF DESCRIPTION OF THE DRAWINGS

FIG. 1 is a block diagram showing a facsimile machine and an extension unit according to a first embodiment of the present invention.

FIG. 2 is a block diagram showing an inner configuration of a transmission image generating unit of FIG. 1.

FIG. 3A shows an example of a page image generated by a first page image generating unit of FIG. 2. FIG. 3B shows an example of a page image generated by the extension unit in accordance with printing data generated by a second page image generating unit of FIG. 2.

FIG. 4A shows an example of a page image of a cover page generated by the first page image generating unit of FIG. 2. FIG. 4B shows an example of a page image of a cover page generated by the extension unit in accordance with the printing data generated by the second page image generating unit of FIG. 2.

FIG. 5 is a flowchart showing an example of a process carried out by the transmission image generating unit of FIG. 2.

FIG. 6 is a block diagram showing a facsimile machine and an extension unit according to a second embodiment of the present invention.

FIG. 7 is a block diagram showing an inner configuration of an imaging unit of FIG. 6.

FIG. 8 is a flowchart showing an example of a process carried out by the imaging unit of FIG. 7.

### DETAILED DESCRIPTION OF THE PREFERRED EMBODIMENTS

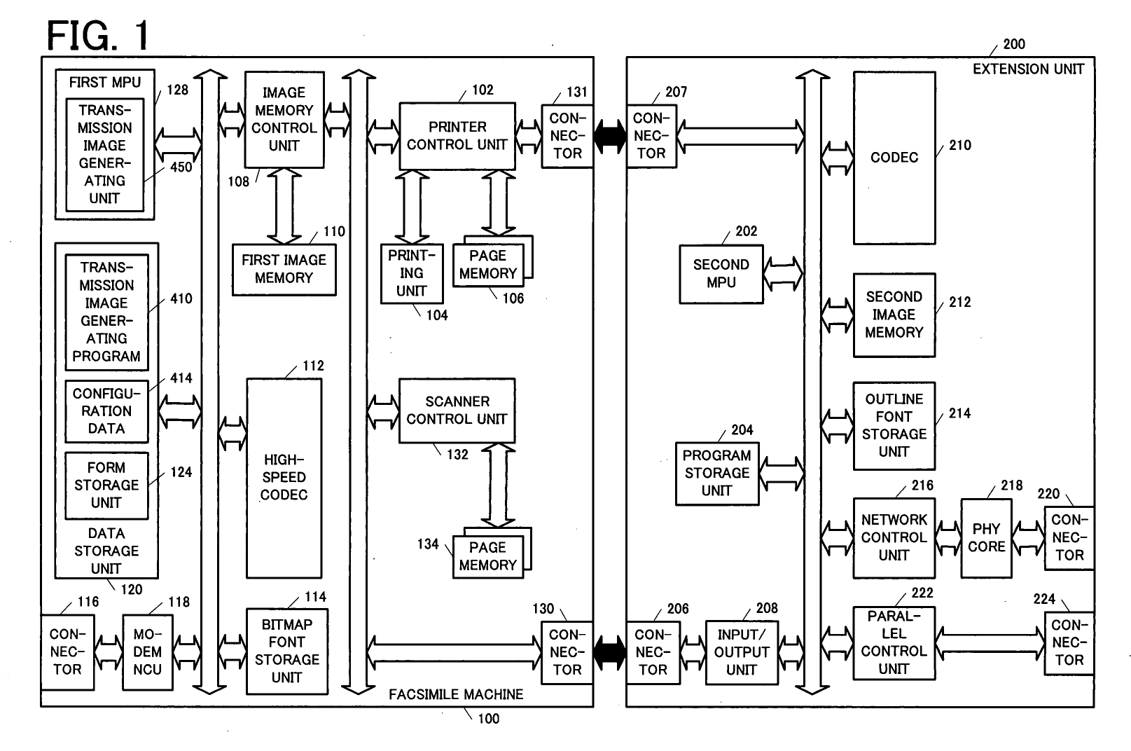

FIG. 1 is a block diagram showing a facsimile machine 100 as a communication device and an extension unit 200 according to a first embodiment of the present invention. The extension unit 200 is an optional unit for extending a function to the facsimile machine 100. For example, the extension unit 200 can be disposed inside a housing of the facsimile machine 100. In the first embodiment, the extension unit 200 adds a printer function to the facsimile machine 100 for printing out printing data received from a personal computer or the like.

A first connector 116 is a connection terminal such as a modular jack for physically connecting the facsimile machine 100 to a public network. A modem/Network Control Unit (NCU) 118 is a functional block for transmitting and receiving facsimile data in accordance with a facsimile communication protocol. For example, the modem/NCU 118 includes a modem and a NCU. When establishing a connection using the public network, the NCU connects to the public network and the modem or a Digital Service Unit (DSU) and establishes communication with another facsimile machine. The modem modulates and demodulates the facsimile data or the like.

The facsimile data is a series of data transmitted and received in accordance with a facsimile protocol. An image scanned by a scanner of the facsimile machine will be referred to as “scanned image” or “scanned image data”. The facsimile machine of a receiving side generates on a paper, a page image including the scanned image and transmitter information or the like, and encodes the page image in accordance with a Joint Bi-Level Image Group (JPIG) encoding method, a Modified Modified Read (MMR) encoding method or the like. The data of the page image encoded as described above will be referred to as a “facsimile image” or “facsimile image data”. The facsimile machine of the receiving side can output the original page image, in other words, the facsimile document, by decoding the facsimile image data.

A scanner control unit 132 scans a transmission document as the facsimile data, and generates the scanned image data. A page memory 134 for the scanner temporarily stores the scanned image data. For example, the page memory 134 is used as a buffer when sequentially transmitting the scanned image data while scanning the document by the scanner. An image memory control unit 108 stores in a first image memory 110, the facsimile data received by the modem/NCU 118 and the scanned image data generated by the scanner control unit 132.

When the facsimile machine 100 is a transmitter, a high-speed codec 112 fetches the page image data from the first image memory 110 and encodes the page image data to generate the facsimile image data. When the facsimile machine 100 is a recipient, the high-speed codec 112 fetches the facsimile image data included in the facsimile data from the first image memory 110 and decodes the facsimile image data to generate the page image data. Then, the high-speed codec 112 temporarily stores the page image data in a page memory 106. A printing unit 104 fetches the page image data from the page memory 106 via a printer control unit 102 and prints out the page image data.

A first Micro Processing Unit (MPU) 128 executes various programs stored in a data storage unit 120, and controls hardware components of the facsimile machine 100. In the first embodiment, the first MPU 128 fetches a transmission image generating program 410 from the data storage unit 120 and executes the transmission image generating program 410. Accordingly, a transmission image generating unit 450 is formed. When the facsimile machine 100 is the transmitter, the transmission image generating unit 450 is activated to generate the page image to be transmitted to a destination.

The transmission image generating unit 450 generates a cover page or appends transmitter information or the like to the scanned image to generate the page image data at a time of transmission. The information generated and appended automatically by the transmission image generating unit 450 will be referred to as “additional information”. Although the details will be described later, when the extension unit 200 is equipped, the transmission image generating unit 450 can generate the additional information by using an outline font stored in the extension unit 200. When the extension unit 200 is not equipped, the additional information can be generated by using a bitmap font stored in a bitmap font storage unit 114. That is, when replacing the character not performed with the imaging process yet, in other words, text information, with a character corresponding to a character code, the transmission image generating unit 450 operates to replace the character by using the outline font of the extension unit 200.

A form storage unit 124 has two types of forms for printing with the bitmap font and for printing with the outline font. For example, the forms are necessary information for generating the cover page or appending the transmitter information. The form for the bitmap font includes information for specifying a data item to be inserted (hereinafter referred to as “item name”) and information for designating an arrangement of the data (hereinafter referred to as “arrangement information”). The form for the outline font includes an item name, arrangement information, a size of the character for printing, and a type of character decoration or the like. As described above, by setting as the form of information that designates the size of the character or the type of the character decoration, the size of the character can be changed or the character can be decorated to increase visibility according to a level of importance of the information appended automatically. Configuration data 414 includes data that can be inserted as the additional information such as the transmitter information (various pieces of information relating to the facsimile machine 100) or a telephone directory, information designating whether or not to generate the cover page automatically, and information designating whether or not to automatically append the transmitter information or the like.

The facsimile machine 100 can function as a printer by being connected electrically with the extension unit 200 via a second connector 130 and a third connector 206 and also a sixth connector 131 and a seventh connector 206. The sixth connector 131 and the seventh connector 207, which constitutes a first route, are used mainly for transmission of the image data necessary for printing, in other words, the bitmap image. The second connector 130 and the third connector 206, which constitutes a second route, are used mainly for transmission of control information or the like necessary for the facsimile machine 100 and the extension unit 200 to operate in cooperation with one another. In FIG. 1, there are two routes of connectors, but as another example, the connectors can be organized in one route.

A fourth connector 220 is a connection terminal for physically establishing a connection with a network such as a Local Area Network (LAN) or a Wide Area Network (WAN). A network control unit 216 is connected to a client computer via a PHY core 218, which executes a process of the physical layer, and a fourth connector 220. For example, the network control unit 216 receives printing data in the PJL/PDL format. A parallel control unit 222 receives printing data from a computer connected via a fifth connector 224 which is a terminal such as a Universal Serial Bus (USB), a parallel, or a serial terminal. The network control unit 216 and the parallel control unit 222 are an input unit for receiving printing data from other than the facsimile machine 100.

A codec 210 rasterizes the printing data and generates bitmap image data. In this case, the codec 210 uses the outline font stored in the outline font storage unit 214 according to necessity. The codec 210 encodes the image data by the MMR encoding method or the like and generates the facsimile image. The second image memory 212 can store the image data temporarily or store the printing data temporarily. An input/output unit 208 transmits and receives various pieces of information between the extension unit 200 and the facsimile machine 100 for a collaborative work. The image data generated by the codec 210 is stored into the page memory 106 of the facsimile machine 100 via the seventh connector 207 and the sixth connector 131, and printed out by the printing unit 104. The facsimile machine 100 can function as a printer by being equipped with the extension unit 200.

When the printing data for generating the page image is supplied from the facsimile machine 100 by an instruction of the transmission image generating unit 450, the input/output unit 208 accepts an input of the printing data. Then, the codec 210 rasterizes in accordance with the printing data, and generates the page image data by using the outline font. The input/output unit 208 outputs the generated page image data to the facsimile machine 100. Then, the page image data is stored in the first image memory 110, encoded by the high-speed codec 112, and transmitted as the facsimile image data.

A second MPU 202 executes various programs stored in a program storage unit 204 and forms various functions. For example, the codec 210 can be formed by executing a program.

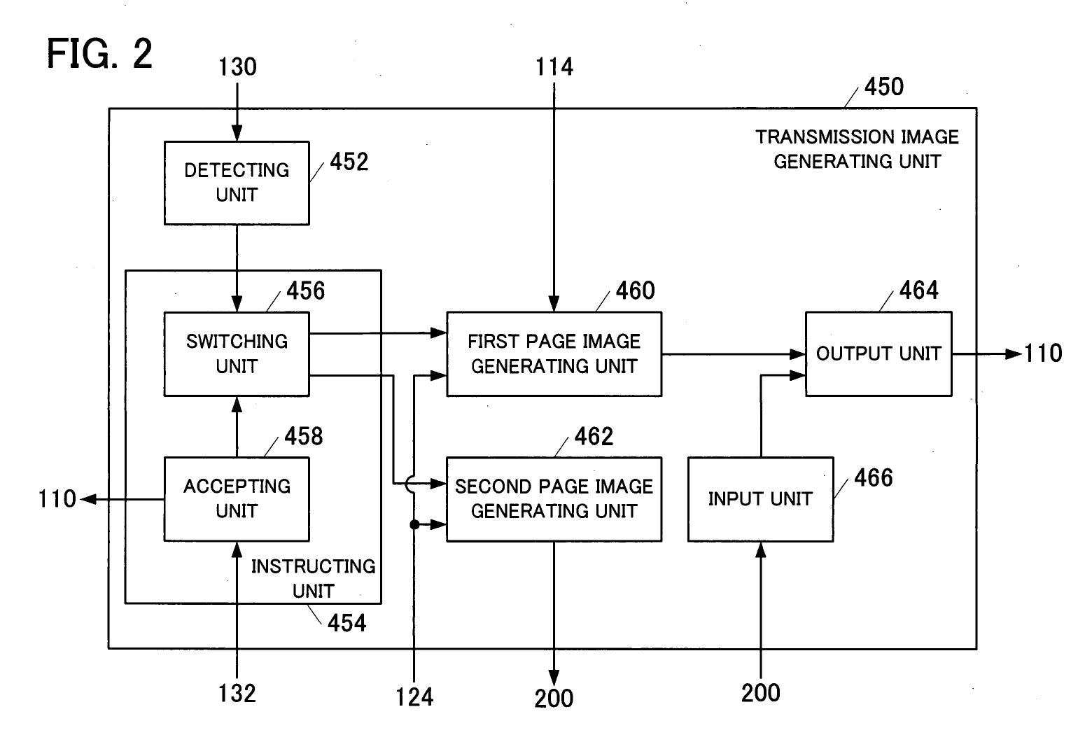

FIG. 2 is a block diagram showing an inner configuration of the transmission image generating unit 450 of FIG. 1. A first page image generating unit 460 generates the page image data by using the bitmap font stored in the bitmap font storage unit 114, and the form for the bitmap font that is stored in the form storage unit 124. Then, the first page image generating unit 460 stores the generated page image data to an output unit 464. The output unit 464 supplies the page image data in the first image memory 110 of FIG. 1. Then, the high-speed codec 112 of FIG. 1 encodes the page image data and generates facsimile image data.

A second page image generating unit 462 generates printing data and outputs the generated printing data to the extension unit 200 in accordance with the form for the outline font stored in the form storage unit 124. An input unit 466 accepts from the extension unit 200, an input of the page image data generated in accordance with the printing data, and supplies the input page image data to the output unit 464.

A detecting unit 452 detects whether or not each of the connectors of the facsimile machine 100 and the extension unit 200 is connected electrically. For example, the detection can be carried out by detecting a voltage level of a prescribed pin of the second connector 130 and the sixth connector 131 of FIG. 1. An instructing unit 454 includes an accepting unit 458 and a switching unit 456. Further, the accepting unit 458 accepts the scanned image data from the scanner control unit 132 of FIG. 1. The switching unit 456 instructs to generate the page image data to either one of the first page image generating unit 460 or the second page image generating unit 462 according to a presence or an absence of the connection with the extension unit 200 when accepting the scanned image data. When the extension unit 200 is not connected, the switching unit 456 instructs the first page image generating unit 460 to execute the process for generating the page image data. When the extension unit 200 is connected, the switching unit 456 instructs the second page image generating unit 462 to execute the process for generating the page image data. Accordingly, when the extension unit 200 is connected to the facsimile machine 100, the facsimile machine 100 can generate the page image which the additional information is appended in legible characters by the outline font.

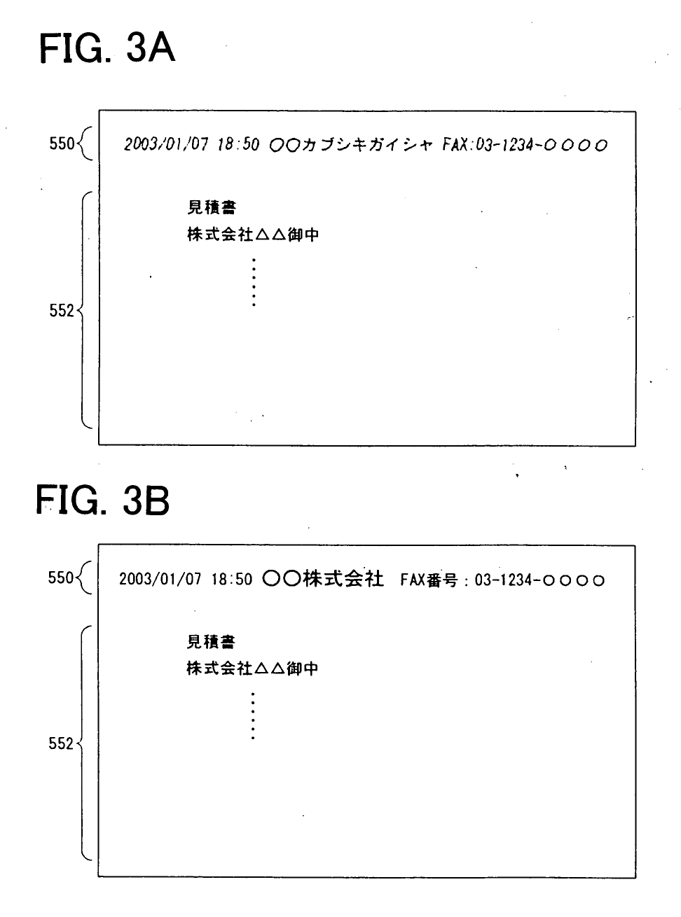

FIG. 3A shows an example of the page image generated by the first page image generating unit 460 of FIG. 2. The page image includes an additional information printing area 550 with the transmitter information and a transmission image printing area 552 with the scanned image. Since the transmitter information appended in the additional information printing area 550 is in the bitmap font, there is aliasing. FIG. 3B shows an example of the page image generated by the extension unit 200 in accordance with the printing data generated by the second page image generating unit 462 of FIG. 2. This page image also includes the additional information printing area 550 and the transmission image printing area 552. In the additional information printing area 550, the transmitter information is appended in the outline font. Moreover, when the character decoration is designated in this form, since the designated decoration is applied, the visibility can be improved. One of the page images is encoded by the high-speed codec 112 of FIG. 1 and transmitted to the destination as the facsimile data.

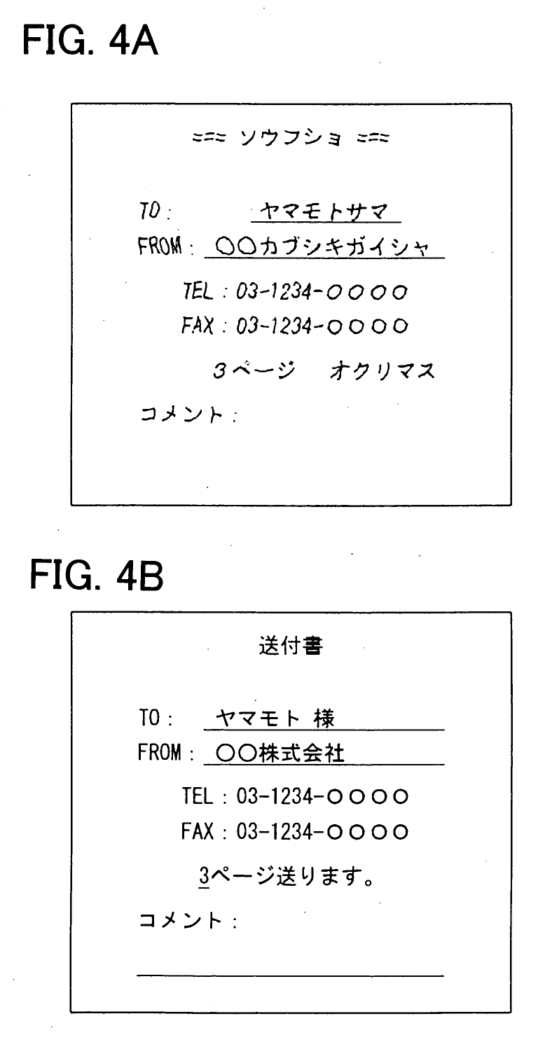

FIG. 4A shows an example of the page image of a cover page generated by the first page image generating unit 460 of FIG. 2. Since the bitmap font is used for this cover page, there is aliasing. FIG. 4B shows an example of the page image generated by the extension unit 200 in accordance with the printing data generated by the second page image generating unit 462 of FIG. 2. One of the page images is encoded by the high-speed codec 112 of FIG. 1 and transmitted to the destination as the facsimile data.

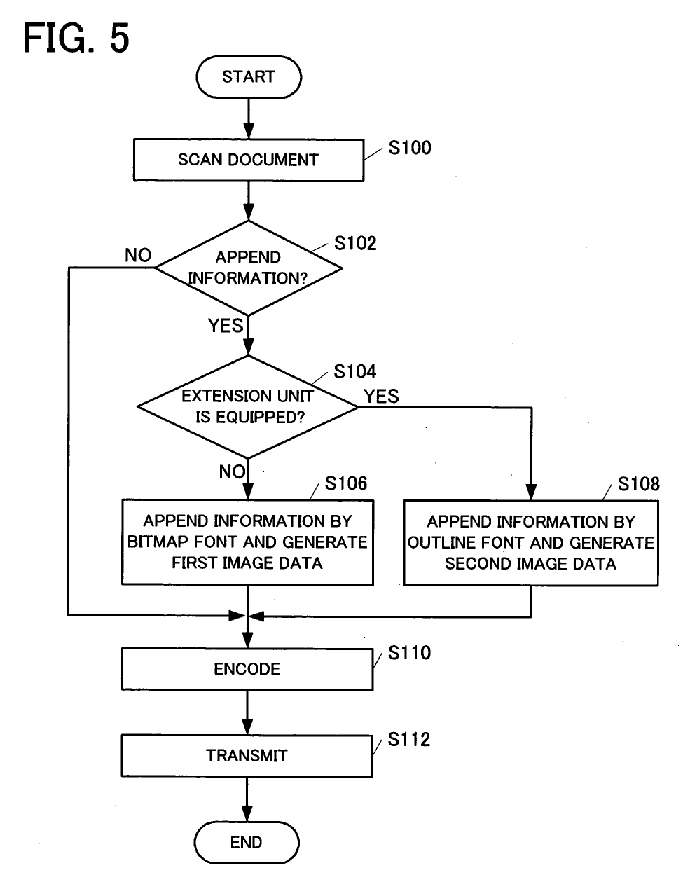

FIG. 5 is a flowcharts showing an example of the transmission process of the facsimile data by the facsimile machine 100 of FIG. 1. The scanner control unit 132 of FIG. 1 scans a document (step S100), and generates the scanned image data. When receiving the scanned image data, the instructing unit 454 of FIG. 2 determines whether or not to append the additional information such as the cover page or the transmitter information (step S102). The determination can be carried out in accordance with the configuration data 414 stored in the data storage unit 120 of FIG. 1.

When appending the additional information (step S102: YES), the detecting unit 452 of FIG. 2 determines whether or not the facsimile machine 100 is equipped with the extension unit 200 (step S104). When the extension unit 200 is not equipped (step S104: NO), the first page image generating unit 460 generates the page image data by using the bitmap font (step S106). Then, the high-speed codec 112 encodes the page image data (step S110). Then, the modem/NCU 118 transmits the facsimile data (step S112).

When the extension unit 200 is equipped in step S104 (step S104: YES), the second page image generating unit 462 generates the printing data and the is extension unit 200 generates the page image data in accordance with the printing data (step S108). Then, the process proceeds to the encoding process (step S110). When not appending the additional information in step S102 (step S102: NO), the scanned image data is encoded as the page image data without appending the transmitter information or the like (step S110). Accordingly, when the facsimile machine 100 is equipped with the extension unit 200, the facsimile machine 100 can transmit the facsimile document which the additional information is appended in legible characters.

A second embodiment is an embodiment where the additional information is appended at the recipient of the facsimile data. As the facsimile communication protocol, a NonStandard facilities Setup signal (hereinafter referred to as “NSS frame”) that can be used by any manufacturer is defined. By adding information for appending the additional information to the NSS frame, it becomes possible to append the additional information at the recipient.

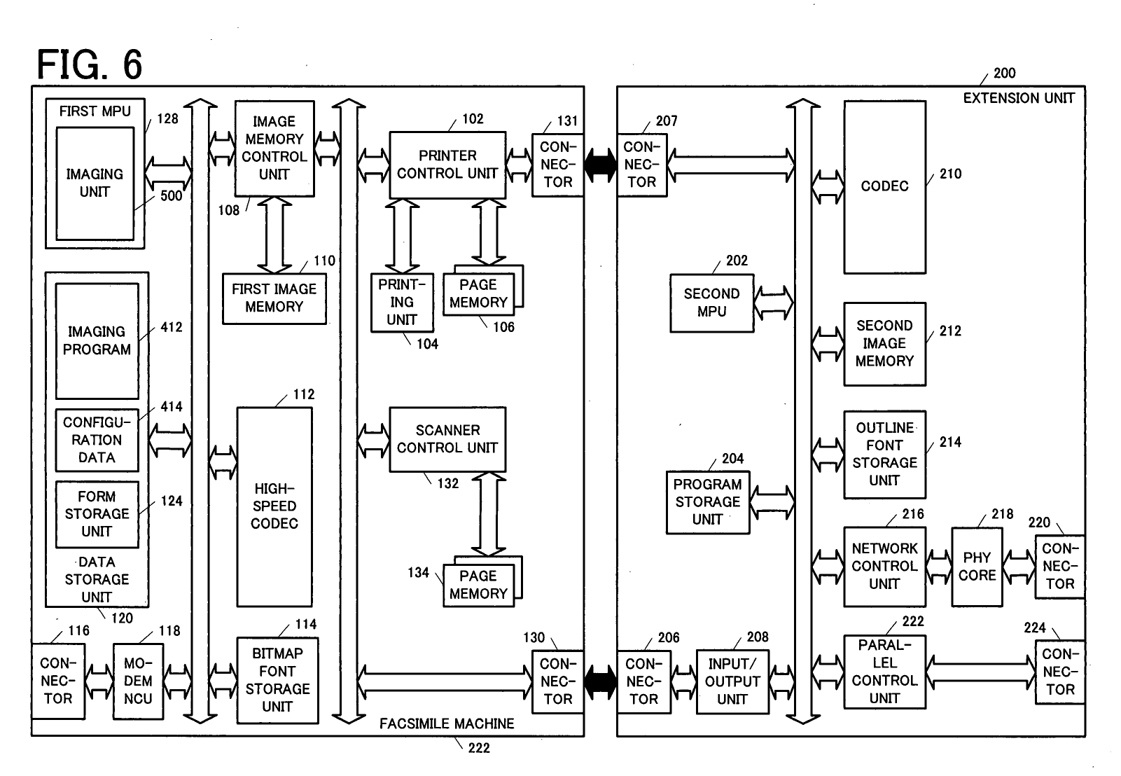

FIG. 6 is a block diagram showing the facsimile machine 100 and the extension unit 200 according to a second embodiment of the present invention. The configuration in FIG. 6 having the same reference numeral as the above-described functional block has the same function and operation as the above-described configuration having the same reference numeral. In the second embodiment, the first MPU 128 fetches an imaging program 412 from the data storage unit 120 and executes the imaging program 412. Accordingly, an imaging unit 500 is formed. When the facsimile machine 100 becomes the recipient, the imaging unit 500 operates to perform imaging of the facsimile image data included in the received facsimile data.

When the information for appending the additional information is included in the received facsimile data, the imaging unit 500 executes a process for generating the page image with the additional information appended. Although the details will be described later, when the extension unit 200 is equipped, the imaging unit 500 can generate the page image data having the transmitter information appended by the outline font of the extension unit 200. When the extension unit 200 is not equipped, the imaging unit 500 can generate the page image data having the transmitter information written by the bitmap font stored in the bitmap font storage unit 114. Since the additional information is generated and printed out at the recipient, the facsimile document is more legible than in the first embodiment where the additional information is appended at the transmission and transmitted.

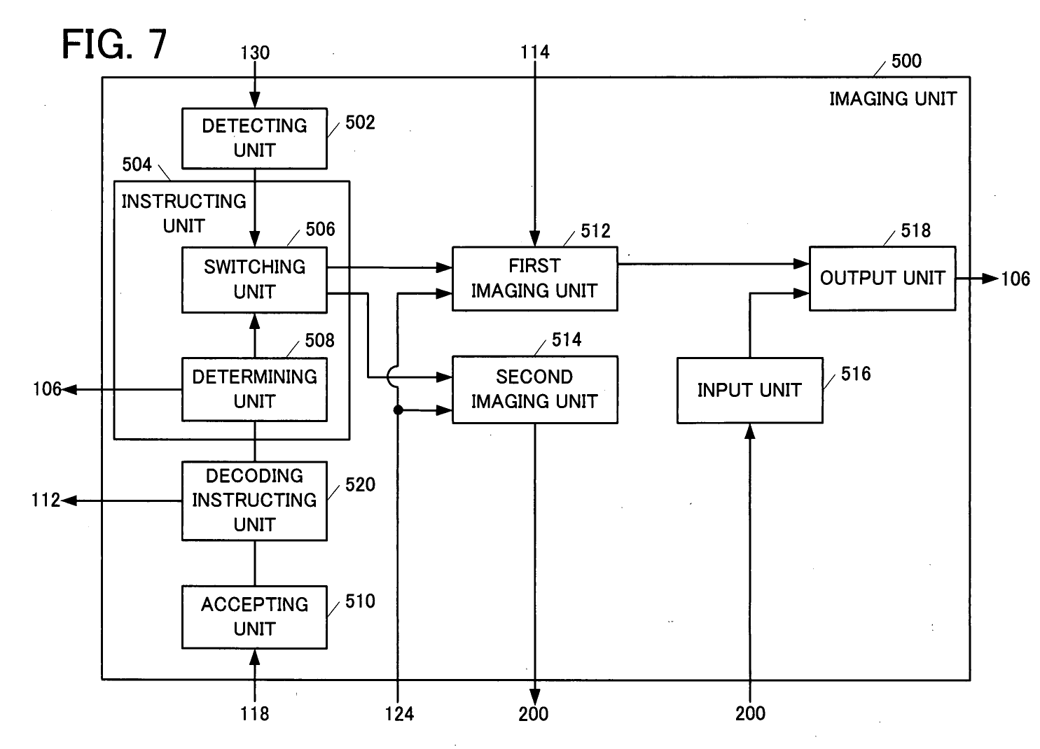

FIG. 7 is a block diagram showing an inner configuration of the imaging unit 500 of FIG. 6. A first imaging unit 512 generates the page image data which the additional information is appended in the bitmap font stored in the bitmap font storage unit 114 or FIG. 6. Then, the first imaging unit 512 supplies the generated page image data to an output unit 518. The output unit 518 stores the page image data in the page memory 106 of FIG. 6. Then, the printing unit 106 of FIG. 4 prints out the document in accordance with the page image data.

A second imaging unit 514 generates the printing data and outputs the generated printing data to the extension unit 200 in accordance with the form for the outline font stored in the form storage unit 124. An input unit 516 accepts from the extension unit 200, an input of the page image data generated in accordance with the printing data and supplies the input page image data to the output unit 518.

A detecting unit 502 detects whether or not each of the connectors of the facsimile machine 100 and the extension unit 200 is connected electrically. For example, the detection can be carried out by detecting a voltage level of a prescribed pin of the second connector 130 and the sixth connector 131 of FIG. 6. An accepting unit 510 accepts an input of the facsimile data from the modem/NCU 118. A decoding instructing unit 520 instructs the high-speed codec 112 to decode the facsimile image data included in the facsimile data. An instructing unit 504 includes a determining unit 508 and a switching unit 506. The determining unit 508 determines whether or not it is necessary to newly append the additional information. The switching unit 506 instructs one of the first imaging unit 512 or the second imaging unit 514 to generate the page image data with the additional information according to the presence or the absence of the extension unit 200.

The determining unit 508 determines whether or not the NSS frame includes the information for appending the additional information. When the information is not included, the determining unit 508 forwards to the page memory 106, the page image data already decoded by the decoding instructing unit 520. When the information for appending the additional information is included, the determining unit 508 instructs the switching unit 506. When the extension unit 200 is not equipped, the switching unit 506 instructs the first imaging unit 512 to generate the page image data. When the extension unit 200 is equipped, the switching unit 506 instructs the second imaging unit 514 to generate the page image data.

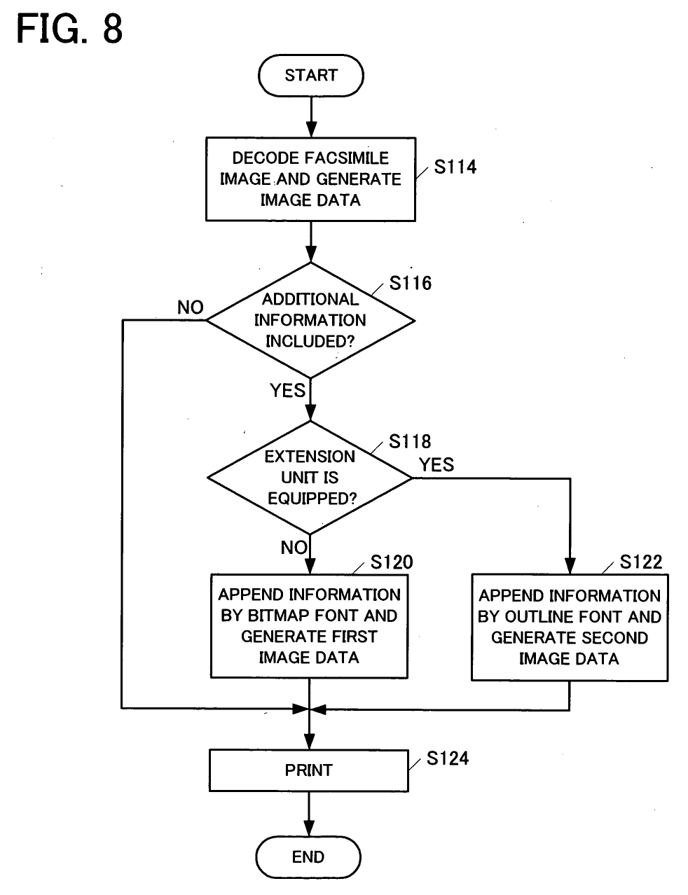

FIG. 8 is a flowchart showing an example of a process carried out by the imaging unit 500 of FIG. 7 when receiving the facsimile data. When the accepting unit 510 of FIG. 7 accepts the facsimile data, the decoding instructing unit 520 instructs the high-speed codec 112 of FIG. 6 to decode the facsimile image included in the facsimile data. Then, the high-speed codec 112 generates the image data (step S114). The determining unit 508 of FIG. 7 determines whether or not the information for appending the additional information is included in the NSS frame (step S116). When the information is not included (step S116: NO), the determining unit 508 forwards the already decoded page image data to the page memory 106 of FIG. 6. Then, the printing unit 104 of FIG. 6 prints out in accordance with the page image data (step S124).

When the information for appending the additional information is included in the NSS frame (step S116: YES), the instructing unit 504 determines whether or not the facsimile machine 100 is equipped with the extension unit 200 (step S118). When the extension unit 200 is not equipped (step S118: NO), the first imaging unit 512 generates the page image data which the additional information is appended in the bitmap font (step S120). Moreover, when the extension unit 200 is equipped (step S118: YES), the second imaging unit 514 generates the page image data which the additional information is appended in the outline font (step S122). Then, the page image data generated by either one of the first imaging unit 512 or the second imaging unit 514 is printed out by the printing unit 104 (step S124).

The foregoing invention has been described in terms of preferred embodiments. However, those skilled in the art will recognize that many variations of such embodiments exist. Such variations are intended to be within the scope of the present invention and the appended claims.

As one variation, a configuration for implementing the transmission image generating unit 450 of the first embodiment and the configuration for implementing the imaging unit 500 of the second embodiment can be combined.

Moreover, when the text data is supplied to the facsimile machine 100 of FIG. 1, the codec 210 of FIG. 1 performs imaging of each of the characters included in the text data by using the outline font. Accordingly, the printing unit 104 can print out in accordance with the page image generated by using the outline font. Moreover, when the information regarding the destination is included in the text data, the transmission image generating unit 450 can transmit the text data, which the imaging process was performed on by the outline font, as the facsimile document to the destination.

What is claimed is:

1. A communication device having a facsimile function comprising:
means for generating a first transmission image by appending additional information using a bitmap font to an image to be transmitted by facsimile;
means for generating a second transmission image which the additional information is appended to the image using an outline font by an extension unit that prints out using the outline font; and
means for transmitting the first transmission image or the second transmission image in accordance with a facsimile protocol.

2. The communication device having the facsimile function according to claim 1, wherein when the extension unit is usable, the means for generating the second transmission image generates an image of a cover page by the extension unit.

3. A communication device having a facsimile function comprising:
means for receiving facsimile data in accordance with a facsimile protocol;
means for performing imaging of additional information included in the facsimile data using a bitmap font; and
means for performing imaging of the additional information using an outline font by an extension unit that prints out using the outline font.

4. A program to be implemented by a computer comprising:
generating a first transmission image by appending additional information using a bitmap font to an image to be transmitted by facsimile;
generating a second transmission image which the additional information is appended to the image using an outline font by an extension unit that prints out by the outline font; and
transmitting the first transmission image or the second transmission image in accordance with a facsimile protocol.

5. A communication device having a facsimile function comprising:
means for generating a first transmission image by appending additional information using a first font to an image to be transmitted by facsimile;
means for generating a second transmission image which the additional information is appended to the image using a second font by an extension unit that prints out by the second font; and
means for transmitting the first transmission image or the second transmission image in accordance with a facsimile protocol.

6. A communication device having a facsimile function comprising:
means for receiving facsimile data in accordance with a facsimile protocol;
means for performing imaging of additional information included in the facsimile data using a first font; and
means for performing imaging of the additional information using a second font by an extension unit that prints out using the second font.

7. A program to be implemented by a computer comprising:
generating a first transmission image by appending additional information using a first font to an image to be transmitted by facsimile;
generating a second transmission image which the additional information is appended to the image using a second font by an extension unit that prints out using the second font; and
transmitting the first transmission image or the second transmission image in accordance with a facsimile protocol.

8. A communication device having a facsimile function comprising:
a first generating unit that generates a first transmission image by appending additional information using a bitmap font to an image to be transmitted by facsimile;
a second generating unit that generates a second transmission image which the additional information is appended to the image using an outline font by an extension unit that prints out using the outline font; and
a transmission unit that transmits the first transmission image or the second transmission image in accordance with a facsimile protocol.

9. The communication device having the facsimile function according to claim 8, wherein when the extension unit is usable, the second generating unit generates an image of a cover page by the extension unit.

10. The communication device having the facsimile function according to claim 8, wherein the bitmap font includes information for specifying a data item to be inserted.

11. The communication device having the facsimile function according to claim 8, wherein the bitmap font includes information for designating an arrangement of data.

12. The communication device having the facsimile function according to claim 8, wherein the outline font includes information for specifying a data item to be inserted.

13. The communication device having the facsimile function according to claim 8, wherein the outline font includes information for designating an arrangement of data.

14. The communication device having the facsimile function according to claim 8, wherein the outline font includes a type of character decoration.

15. The communication device having the facsimile function according to claim 8, wherein the outline font includes a size of a character.

16. The communication device having the facsimile function according to claim 1, wherein the bitmap font includes information for specifying a data item to be inserted.

17. The communication device having the facsimile function according to claim 1, wherein the bitmap font includes information for designating an arrangement of data.

18. The communication device having the facsimile function according to claim 1, wherein the outline font includes information for specifying a data item to be inserted.

19. The communication device having the facsimile function according to claim 1, wherein the outline font includes information for designating an arrangement of data.

20. The communication device having the facsimile function according to claim 1, wherein the outline font includes a type of character decoration.
